(19) United States
(12) Patent Application Publication
(10) Pub. No.: US 2007/0157957 A1
(43) Pub. Date: Jul. 12, 2007

(54) Substrate transfer robot and apparatus having the substrate transfer robot for cleaning a substrate

(75) Inventors: Duk-Lyol Lee, Hwaneong-si (KR); Mo-Hyun Cho, Suwon-si (KR); Dong-chul Heo, Gunpo-si (KR); Kyung-Seuk Hwang, Suwon-si (KR)

Correspondence Address: MILLS & ONELLO LLP, ELEVEN BEACON STREET, SUITE 605, BOSTON, MA, 02108, US

(73) Assignee: Samsung Electronics Co., Ltd.

(21) Appl. No.: 11/649,485

(22) Filed: Jan. 4, 2007

(30) Foreign Application Priority Data
Jan. 9, 2006 (KR) 10-2006-0002072

(51) Int. Cl. B08B 3/00; B65H 1/00; C23F 1/00

(52) U.S. Cl. 134/56 R; 414/222.01; 156/345.31; 134/95.2

(57) ABSTRACT

In a substrate transfer robot and a substrate cleaning apparatus, the substrate transfer robot transfers substrates between a container supported by a load port and a processing module for cleaning the substrates. The substrate transfer robot includes a driving member that provides a driving force to transfer the substrates, a blade that transfers the substrates using the driving force, and a sensor that senses impurities existing on the blade. When the impurities are detected, a controller can control the operation of the driving member. Thus, the contamination of other substrates in the container can be effectively prevented.

### CROSS-REFERENCE TO RELATED APPLICATION

This application claims priority under 35 USC §119 to Korean Patent Application No. 10-2006-0002072, filed on Jan. 9, 2006, the contents of which are herein incorporated by reference in their entirety.

### BACKGROUND OF THE INVENTION

1. Field of the Invention

Example embodiments of the present invention relate to a substrate transfer robot and an apparatus having the substrate transfer robot for cleaning a substrate. More particularly, example embodiments of the present invention relate to a substrate transfer robot for transferring a substrate between a container for receiving the substrate and a processing module for cleaning the substrate, and an apparatus having the substrate transfer robot to clean the substrate.

2. Description of the Related Art

Semiconductor devices are manufactured generally by repetitively performing a plurality of processes. For example, the semiconductor devices can be fabricated by repetitively carrying out a series of unit processes including a layer formation process, a photolithography process, an etching process, an ion implantation process, a diffusion process, a planarization process, a test process, a cleaning process, a drying process, etc.

In the cleaning process, undesired materials are removed from layers and/or conductive patterns formed on a semiconductor substrate such as a silicon wafer.

The cleaning process can be carried out using a batch-type cleaning apparatus or a single-type cleaning process. The batch-type cleaning apparatus may simultaneously clean a plurality of substrates, whereas the single-type cleaning apparatus commonly sequentially cleans each of the substrates. The batch-type cleaning apparatus includes a batch having a cleaning solution where the plurality of the substrates is simultaneously immersed. An ultrasonic vibration can be applied to the cleaning solution contained in the bath so as to improve a cleaning efficiency of the substrates. The single-type cleaning apparatus can include a chuck and nozzles. The chuck may support the substrates, and the nozzles may supply a cleaning solution to front and rear faces of the substrates. An ultrasonic vibration can also be applied to the cleaning solution provided onto the substrates.

The single-type cleaning apparatus can include a container, a load port, a substrate transfer robot and a processing module. The container receives a plurality of semiconductor substrates, and the load port may support the container. The substrate transfer robot transfers the semiconductor substrates between the container and the processing module where a cleaning process is performed on the semiconductor substrates.

The substrate transfer robot of the single-type cleaning apparatus removes one of the semiconductor substrates from the container, and then transfers the semiconductor substrate to the processing module. The processing module includes a spin chuck, a first solution providing member and a second solution providing member. The spin chuck supports and revolves the transferred semiconductor substrate. The first and the second solution providing members provide a cleaning solution and a rinsing solution to an upper face and a lower face of the substrate, respectively.

While the semiconductor substrate rotates, the cleaning solution and the rinsing solution are successively supplied to the semiconductor substrate. Undesired materials on the semiconductor substrate are removed by the cleaning and the rinsing solutions and then, the semiconductor substrate is dried by rotating the spin chuck at a high rotation speed.

While the semiconductor substrate is transferred to the processing module or the dried substrate is transferred from the processing module, liquid-phased impurities such as the cleaning solution or the rinsing solution can exist on a face of a blade or an end effecter of the substrate transfer robot. These liquid-phased impurities can operate to contaminate other semiconductor substrates received in the container. Particularly, the liquid-phased impurities existing on a lower face of the blade may be dropped onto other semiconductor substrates in the container so that drops of the liquid-phased impurities on the semiconductor substrates cause defects such as water marks. Further, the liquid-phased impurities on the lower face of the blade can make contact with faces of the semiconductor substrate received in the container while transferring the semiconductor substrates. This can cause a serious defect to occur on the faces of the semiconductor substrates.

### SUMMARY OF THE INVENTION

Example embodiments of the present invention provide a substrate transfer robot for sensing impurities existing on a blade for transferring a substrate.

Example embodiments of the present invention provide a substrate cleaning apparatus including a substrate transfer robot for sensing impurities existing on a blade for transferring a substrate.

According to one aspect of the present invention, there is provided a substrate transfer robot including a driving member, a blade and a sensor. The driving member provides a driving force to transfer a substrate. The blade transfers the substrate using the driving force. The sensor is disposed on the blade to sense impurities existing on the blade.

In an example embodiment of the present invention, the impurities comprise liquid-phased impurities.

In some example embodiments of the present invention, the sensor can include a conductive line, a power source and an ammeter. The conductive line can be disposed on the blade. The power source can apply a sensing current to the conductive line. The ammeter can be electrically connected to the conductive line to measure the sensing current.

In an example embodiment of the present invention, the sensor can further include a resistive element electrically connected to the conductive line in serial.

In an example embodiment of the present invention, the conductive line can be shaped in a zigzag pattern.

In some example embodiments of the present invention, the sensor can include a light emitting member and a light receiving member. The light emitting member can be disposed at a first peripheral portion of the blade, and the light receiving member can be disposed at a second peripheral portion of the blade. The light emitting member can be opposed to the light receiving member.

In some example embodiments of the present invention, the substrate transfer robot can additionally include a controller that controls an operation of the driving member in accordance with a sensing signal generated from the sensor.

According to another aspect of the present invention, there is provided a substrate cleaning apparatus including a load port, a processing module and a substrate transfer robot. The load port can support a container receiving a plurality of substrates. The substrates are cleaned at a processing module. The substrate transfer robot can be disposed between the load port and the processing module to transfer the substrates. The substrate transfer robot includes a driving member that provides a driving force to transfer the substrates, a blade that transfers the substrates using the driving force, and a sensor disposed on the blade to sense impurities existing on the blade.

In some example embodiments of the present invention, the impurities comprise a cleaning solution or a rinsing solution used in cleaning the substrates.

In some example embodiments of the present invention, the sensor can include a conductive line disposed on the blade, a resistive element electrically connected to the conductive line in serial, a power source that applies a sensing current to the conductive line, and an ammeter electrically connected to the conductive line to measure the sensing current.

In some example embodiments of the present invention, the sensor may include a light emitting member disposed at a first peripheral portion of the blade and a light receiving member disposed at a second peripheral portion of the blade. The light emitting member may be positioned opposed to the light receiving member.

In some example embodiments of the present invention, the substrate cleaning apparatus can include a controller that controls an operation of the driving member in accordance with a sensing signal generated from the sensor.

In some example embodiments of the present invention, the substrate transfer robot can be disposed between the load port and the processing module.

In some example embodiments of the present invention, the processing module can include a spin chuck, a first solution providing member and a second solution providing member. The spin chuck can support and revolve the substrate transferred by the substrate transfer robot. The first solution providing member can provide a cleaning solution and a rinsing solution onto upper faces of the substrates supported by the spin chuck. The second solution providing member can provide the cleaning solution and the rinsing solution onto lower faces of the substrates supported by the spin chuck.

In some example embodiments of the present invention, the processing module can additionally include an ultrasonic transducer and a probe. The ultrasonic transducer is configured to generate an ultrasonic energy. The probe can be coupled to the ultrasonic transducer and can be disposed adjacent to the substrates so as to is apply the ultrasonic energy to the cleaning solution provided on the substrates.

In some example embodiments of the present invention, the spin chuck can include a rotation driving member, a rotation axle, a plurality of spokes, an outer rim and a plurality of supporting members. The rotation driving member provides a rotation force to revolve the substrates. The rotation axle can be connected to the rotation driving member. The plurality of spokes radially extend from the spin chuck. The outer rim can be supported by the spokes. The plurality of supporting members can be disposed on the outer rim to support the substrates.

In an example embodiment of the present invention, the second solution providing member can include a plurality of nozzles that provide the cleaning solution and the rinsing solution onto the lower faces of the substrates. The nozzles may be disposed under the substrates supported by spokes and can be elongated in parallel with the lower faces of the substrates.

In an example embodiment of the present invention, the processing module can additionally include an additional sensor disposed on the second solution providing member to sense impurities existing on the substrates supported by the spin chuck.

In an example embodiment of the present invention, the processing module can further include a dry gas providing member that provides a dry gas onto the substrates to dry the substrates rinsed using the rinsing solution.

According to the present invention, a first sensor detects impurities existing on or beneath a blade that is used to transport wafers or substrates, and a controller operates to control an operation of a substrate transfer robot. Thus, contaminations of other substrates received in a container due to the impurities can be sufficiently prevented.

### BRIEF DESCRIPTION OF THE DRAWINGS

The above and other features and advantages of the present invention will become more apparent by describing in detailed example embodiments thereof with reference to the accompanying drawings, in which:

FIG. 1 is a cross-sectional view illustrating a substrate cleaning apparatus in accordance with example embodiments of the present invention;

FIG. 2 is a bottom view illustrating a first sensor in FIG. 1 according to some example embodiments of the present invention;

FIG. 3 is a bottom view illustrating a first sensor of the substrate cleaning apparatus in FIG. 1 according to other example embodiments of the present invention;

FIG. 4 is an exploded cross-sectional view illustrating a processing module in FIG. 1 according to example embodiments of the present invention;

FIG. 5 is a perspective view for illustrating a spin chuck and a second solution providing member in FIG. 1 according to example embodiments of the present invention; and

FIG. 6 is a bottom view illustrating a blade of a substrate transfer robot in accordance with example embodiments of the present invention.

### DETAILED DESCRIPTION OF EMBODIMENTS

The present invention is described more fully hereinafter with reference to the accompanying drawings, in which example embodiments of the present invention are shown. The present invention may, however, be embodied in many different forms and should not be construed as limited to the embodiments set forth herein. Rather, these embodiments are provided so that this disclosure will be thorough and complete. In the drawings, the sizes and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another elements or features as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented rotated 90 degrees or at other orientations and the spatially relative descriptors used herein interpreted accordingly.

The terminology used herein is for the purpose of describing particular embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments of the present invention are described herein with reference to cross-section illustrations that are schematic illustrations of idealized embodiments and intermediate structures of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms including technical and scientific terms used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

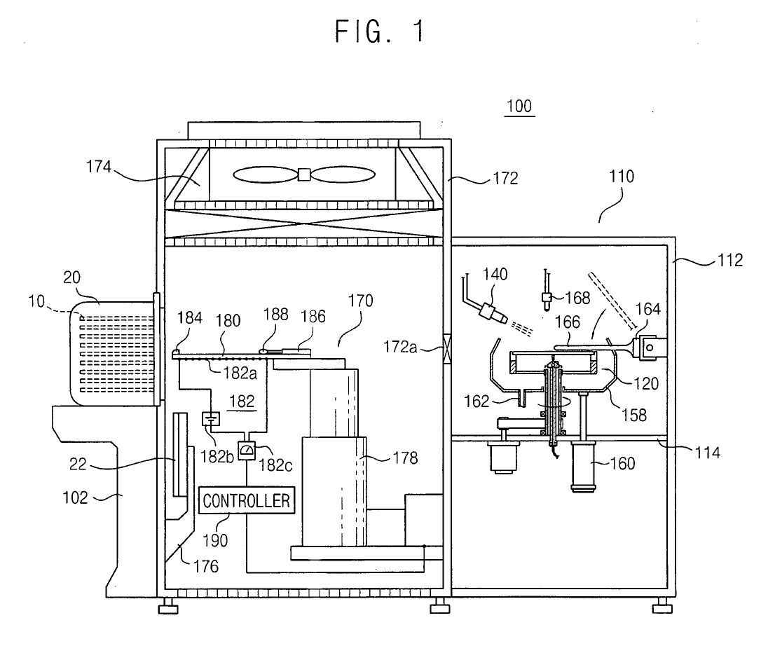

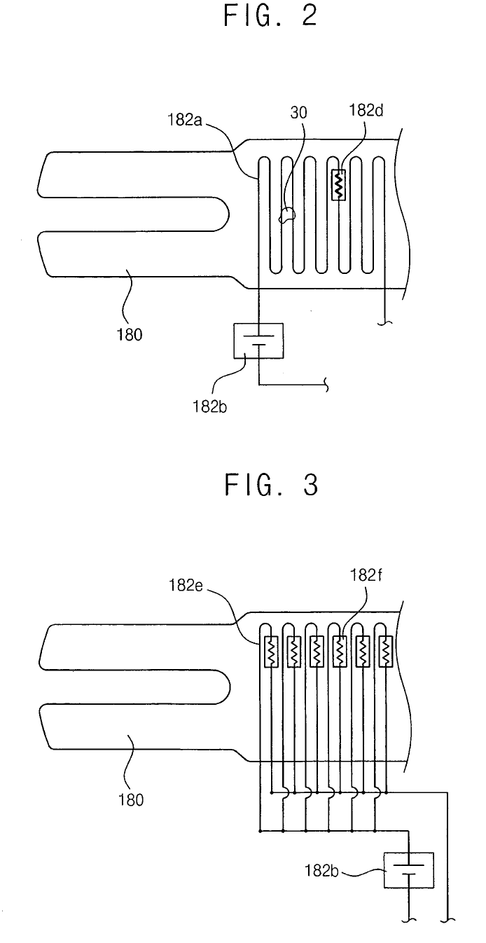

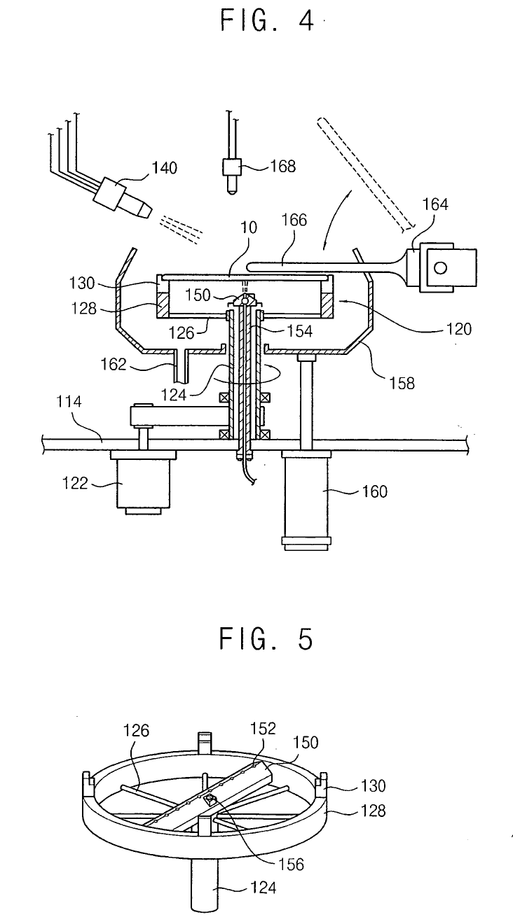

FIG. 1 is a cross-sectional view illustrating a substrate cleaning apparatus in accordance with example embodiments of the present invention. FIG. 2 is a bottom view illustrating a first sensor in FIG. 1 according to some example, embodiments of the present invention. FIG. 3 is a bottom view illustrating a first sensor of the substrate cleaning apparatus in FIG. 1 according to other example embodiments of the present invention. FIG. 4 is an exploded cross-sectional view illustrating a processing module in FIG. 1 according to example embodiments of the present invention.

Referring to FIGS. 1 to 3, a substrate cleaning apparatus 100 includes a load port 102, a processing module 110 and a substrate transfer robot 170.

The load port 102 supports a container 20 having a plurality of substrates 10 such as silicon wafers. The processing module 110 cleans and dries the substrates 10. The substrate transfer robot 170 transfers the substrates 10 between the container 20 and the processing module 110.

In some example embodiments of the present invention, a front open unified pod (FOUP) can be disposed on the load port 102. The FOUP accommodates the plurality of the substrates 10. The substrate transfer robot 170 can be disposed in a substrate transfer chamber 172, particularly, in a space of the substrate transfer chamber 172 where the substrates 10 are transferred between the load port 102 and the processing module 110.

A fan filter unit (FFU) 174 can be disposed on the substrate transfer chamber 172 to provide the space of the substrate transfer chamber 172 with clean air. A plurality of holes can be formed through a bottom panel of the substrate transfer chamber 172 so as to exhaust air from the space of the substrate transfer chamber 172 to an external location. Additionally, a door opener 176 can be disposed in the substrate transfer chamber 172 to open and close a cover 22 of the container 20.

The substrate transfer robot 170 selects and removes one of the substrates 10 received in the container 20, and transports the selected substrate to the processing module 110. Further, the substrate transfer robot 170 transports the substrate processed by the processing module 110 into the container 20.

The substrate transfer robot 170 can include a driving member 178, a blade 180 and a first sensor 182. The driving member 178 provides a driving force for transferring the substrates 10, and the blade 180 transfers the substrates 10 using the driving force provided by the driving member 178. The first sensor 182 can be mounted beneath the blade 180 to detect impurities existing on a lower face of the blade 180.

The blade 180 can be connected to the driving member 178 through a robot arm. A post 184 can be disposed on one end portion of the blade 180, and also a holding member 186 can be mounted on another end portion of the blade 180. The holding member 186 can correspond to the post 184 centering the substrates 10 supported by the blade 180. In one example embodiment, the holding member 186 includes a pneumatic cylinder. When the holding member 186 includes the pneumatic cylinder, an elastic member 188 can be disposed on an end portion of a cylindrical rod of the pneumatic cylinder. The elastic member 188 can be tightly adhered to the substrates 10. In another example embodiment, the blade 180 can hold the substrates 10 using a vacuum or an electrostatic force.

The first sensor 182 can be employed for sensing any impurities that exist on the lower face of the blade 180. For example, the first sensor 182 can detect impurities in their liquid phase, or “liquid-phased” impurities, existing on a lower face of the blade 180. In some example embodiments, the first sensor 182 can detect the presence of a cleaning solution or a rinsing solution on the lower face of the blade 180 while transferring the substrates 10 between the container 20 and the processing module 110.

The first sensor 182 may include a conductive line 182a, a power source 182b and an ammeter 182c. The conductive line 182a can be disposed beneath the lower face of the blade 180. The ammeter 182c can be electrically coupled to the conductive line 182a. The power source 182b can supply a sensing current to the conductive line 182a, and the ammeter 182c measures the sensing current applied to the conductive line 182a.

In some example embodiments of the present invention, a resistive element 182d may be electrically connected to the conductive line 182a in serial. The conductive line 182a disposed beneath the lower face of the blade 180 may have various structures. For example, the conductive line 182a may have a zigzag-shaped structure as shown in FIG. 2. In an example embodiment, a plurality of pairs of conductive lines 182e and resistive elements 182f can be electrically connected in parallel to the power source 182b. The conductive line 182a or the plurality of conductive lines 182e can be disposed beneath an entire lower face of the blade 180 even though the conductive line 182a is shown as being formed beneath only a portion of the lower face of the blade 180 as shown in FIG. 2, or the conductive lines 182e are shown as being positioned beneath only a portion of the lower face of the blade 180 in FIG. 3.

When drops of the liquid-phased impurities 30 exist on the lower face of the blade 180 as shown in FIG. 2, the liquid-phased impurities 30 can serve as an undesired resistance so that the sensing current measured by the ammeter 182c is caused to undesirably vary. A controller 190 is connected to the ammeter 182c to control an operation of the driving member 178 in accordance with variation of the sensing current measured by the ammeter 182c. Therefore, the drops of the liquid-phased impurities 30 are detected and can be prevented from contaminating the other substrates 10 received in the container 20.

FIG. 5 is a perspective view illustrating a spin chuck and a second solution providing member in FIG. 1 according to example embodiments of the present invention.

Referring to FIGS. 1, 4 and 5, the processing module 110 includes a processing chamber 112 connected to the substrate transfer chamber 172 through a gate valve 172a. The substrates 10 transferred by the substrate transfer robot 170 can be loaded on a spin chuck 120 installed in the processing chamber 112.

The spin chuck 120 supports and revolves the substrates 10 so as to clean and dry the substrates 10. The spin chuck 120 includes a rotation driving member 122, a rotation axle 124, and a plurality of spokes 126, an outer rim 128 and a plurality of supporting members 130. The rotation driving member 122 operates to provide a rotation force for revolving the substrates 10, and the rotation axle 124 is connected to the rotation driving member 122. The spokes 126 can radially extend from an upper portion of the rotation axle 124, and the outer rim 128 can be supported by the spokes 126. The supporting members 130 can be disposed on the outer rim 128 to support the substrates 10.

In some example embodiment of the present invention, the rotation driving member 122 can include a motor. The motor may be mounted on a base plate 114 disposed in the processing chamber 112. The motor provides a rotation force to the rotation axle 124 through a belt. The rotation axle 124 can, for example, comprise a hollow shaft.

The processing module 110 can include a first solution providing member 140 and a second solution providing member 150. The first solution providing member 140 can provide a cleaning solution and a rinsing solution to upper faces of the substrates 10 supported by the spin chuck 120. The second solution providing member 150 can provide the cleaning solution and the rinsing solution to lower faces of the substrates 10 supported by the spin chuck 120.

In one example embodiment of the present invention, the cleaning solution includes a hydrofluoric (HF) acid solution and deionized water (H₂O). In another example embodiment, the cleaning solution can include an ammonium hydroxide (NH₄OH) solution, a hydrogen peroxide (H₂O₂) solution and deionized water. In still another example embodiment, the cleaning solution can include an ammonium fluoride (NH₄F) solution, a hydrofluoric acid solution and deionized water. In still another example embodiment, the cleaning solution can include a phosphoric (H₃PO₄) acid solution and deionized water. In some example embodiments, the rinsing solution may include deionized water.

When the cleaning solution includes the hydrofluoric acid solution and deionized water, the cleaning solution can effectively remove native oxide films of silicon oxide formed on the substrates 10 and metal ions on the substrates 10. A volume ratio between the hydrofluoric acid solution and deionized water may be in a range of about 1:100 to about 1:500. However, the volume ratio between the hydrofluoric acid solution and deionized water may be varied in accordance with conditions of a cleaning process.

When the cleaning solution includes the ammonium fluoride solution, the hydrofluoric acid solution and deionized water (referred to as standard cleaning 1 (SC1) solution), the cleaning solution can efficiently remove oxide films formed on the substrates 10 and organic compounds adhered to the substrates 10. A volume ratio among the ammonium fluoride solution, the hydrofluoric acid solution and deionized water may be in a range of about 1:4:20 to about 1:4:100. The volume ratio among the ammonium fluoride solution, the hydrofluoric acid solution and deionized water may vary in accordance with the conditions of the cleaning process.

When the cleaning solution includes the ammonium fluoride solution, the hydrofluoric acid solution and deionized water (referred to as a limulus amoebocyte lysate (LAL) solution), the cleaning solution can easily remove oxide films formed on the substrates 10. When the cleaning solution includes the phosphoric acid solution and deionized water, the cleaning solution may effectively remove nitride-based materials form the substrates 10.

A second solution providing member 150 may be disposed under the substrates 10 supported by the supporting members 130. The second solution providing member 150 may be prolonged in parallel with the lower faces of the substrates 10. The second solution providing member 150 includes a plurality of nozzles 152 for providing the cleaning solution and the rinsing solution to the lower faces of the substrates 10. The second solution providing member 150 may be supported by a supporting shaft 154 extending in a vertical direction through the rotation axle 124. The supporting shaft 154 may include a hollow shaft. The cleaning solution and the rinsing solution can be provided to the substrates 10 through the supporting shaft 154.

In some example embodiments of the present invention, a second sensor 156 can be disposed on the second solution providing member 150. The second sensor 156 is operative to detect impurities existing on the substrates 10 supported by the supporting member 130. For example, the second sensor 156 can detect drops of the cleaning and the rinsing solutions present on portions of the substrates 10 adjacent to the second sensor 156 after performing a cleaning process and a rinsing process. Further, the second sensor 156 can sense the presence of drops of the cleaning and the rinsing solutions existing beneath the lower face of the blade 180.

Referring to FIGS. 1 and 4, a bowl 158 enclosing the spin chuck 120 may be disposed in the processing chamber 112. The bowl 158 may move in a vertical direction by a vertical driving member 160 mounted on a base plate 114. The bowl 158 may move downwardly to load the substrates 10. Additionally, the bowl 158 may move upwardly to enclose the spin chuck 120 while performing the cleaning and the drying processes on the substrates 10. An outlet 162 may be coupled to a lower portion of the bowl 158 to exhaust the cleaning solution and the rinsing solution.

In some example embodiments of the present invention, an ultrasonic transducer 164 and a probe 166 can be installed in the processing chamber 112. The ultrasonic transducer 164 provides an ultrasonic energy, and the probe 166 is coupled to the ultrasonic transducer 164. The probe 166 can be positioned adjacent to the upper faces of the substrates 10 so as to apply the ultrasonic energy to the cleaning solution provided from a first solution providing member 140 onto the upper faces of the substrates 10. The probe 166 can be rotated as shown so as not to interfere with the loading and unloading of the substrates 10. Additionally, the probe 166 can be disposed in parallel to the upper faces of the substrates 10 supported by the spin chuck 120 while performing the cleaning process on the substrates 10. The probe 166 may extend into a central region of the bowl 158 from the upper faces of the substrates 10 supported by the spin chuck 120 through a slot formed at a sidewall of the bowl 158.

After the cleaning process and the rinsing process are carried out, the substrates 10 may be dried by revolving the substrates 10 at a high rotation speed. To effectively dry the substrates 10, a dry gas providing member 168 can be disposed in the process chamber 112. The dry gas providing member 168 can provide a dry gas onto the substrates 10 while revolving the substrates 10. The dry gas can include an isopropyl alcohol (IPA) vapor or a nitrogen gas. These can be used alone or in a mixture thereof. In an example embodiment, the first solution providing member 140 can be integrally formed together with the drying gas providing member 168.

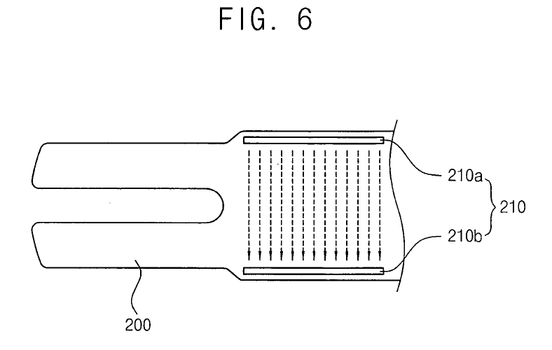

FIG. 6 is a bottom view for illustrating a blade of a substrate transfer robot in accordance with example embodiments of the present invention.

Referring to FIG. 6, the substrate transfer robot includes a driving member, a blade 200 and a first sensor 210. The driving member may provide a driving force for transferring substrates. The blade 200 is operable to transfer the substrates 10, and the first sensor 210 operates to detect impurities that are present on the blade 200.

The first sensor 210 may be disposed on a lower face of the blade 200. The first sensor 210 may include a light emitting member 210a and a light receiving member 210b. The light emitting member 210a and the light receiving member 210b can be positioned at first and second peripheral portions of the blade 200, as shown. The light emitting member 210a can be positioned opposed to the light receiving member 210b, as shown. The light emitting member 210a and the light receiving member 210b operate to detect impurities, for example, liquid-phased impurities, existing on the lower face of the blade 200.

In some example embodiments of the present invention, the light emitting member 210a can irradiate electromagnetic energy, for example light energy, toward the light receiving member 210b, and then the light receiving part 210b detects the light emitted from the light emitting member 210a. In this manner, any impurities present in a position between the light emitting member 210a and the light receiving member 210b can be detected. For example, the first sensor 210 can detect the liquid-phased impurities and particles attached to the lower face of the blade 200.

The first sensor 210 can be electrically connected to a controller. The controller is configured to identify the impurities existing beneath the lower face of the blade 200 in accordance with an intensity variation of the light detected by the light receiving member 210b, and the controller controls the operation of the driving member. That is, the controller can interrupt the operation of the driving member when the first sensor 210 detects the impurities.

According to some example embodiments of the present invention, a first sensor detects impurities existing on or beneath a blade configured to transport substrates in a processing apparatus, and a controller controls the operation of a substrate transfer robot. Thus, contamination of other substrates present in a substrate container as a result of the presence of the impurities can be sufficiently prevented.

The foregoing is illustrative of embodiments of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims.

What is claimed is:

1. A substrate transfer robot comprising:
a driving member that provides a driving force to transfer a substrate;
a blade that transfers the substrate using the driving force; and
a sensor disposed on the blade to sense impurities existing on the blade.

2. The substrate transfer robot of claim 1, wherein the impurities comprise liquid-phased impurities.

3. The substrate transfer robot of claim 2, wherein the sensor comprises:
a conductive line disposed on the blade;
a power source that applies a sensing current to the conductive line; and
an ammeter electrically connected to the conductive line to measure the sensing current.

4. The substrate transfer robot of claim 3, wherein the sensor further comprises a resistive element electrically connected to the conductive line in serial.

5. The substrate transfer robot of claim 3, wherein the conductive line has a zigzag pattern.

6. The substrate transfer robot of claim 1, wherein the sensor comprises a light emitting member disposed at a first peripheral portion of the blade and a light receiving member disposed at a second peripheral portion of the blade, the light emitting member being positioned opposed to the light receiving member.

7. The substrate transfer robot of claim 1, further comprising a controller that controls an operation of the driving member in accordance with a sensing signal generated from the sensor.

8. A substrate cleaning apparatus comprising:
a load port that supports a container receiving a plurality of substrates;
a processing module at which the plurality of substrates are cleaned; and
a substrate transfer robot disposed between the load port and the processing module to transfer the substrates,
wherein the substrate transfer robot comprises:
a driving member that provides a driving force to transfer the substrates;
a blade that transfers the substrates using the driving force; and
a sensor disposed on the blade to sense impurities existing on the blade.

9. The substrate cleaning apparatus of claim 8, wherein the impurities comprise a cleaning solution or a rinsing solution used in cleaning the substrates.

10. The substrate cleaning apparatus of claim 9, wherein the sensor comprises:
a conductive line disposed on the blade;
a resistive element electrically connected to the conductive line in serial;
a power source that applies a sensing current to the conductive line; and
an ammeter electrically connected to the conductive line to measure the sensing current.

11. The substrate cleaning apparatus of claim 8, wherein the sensor comprises a light emitting member disposed at a first peripheral portion of the blade and a light receiving member disposed at a second peripheral portion of the blade, the light emitting member being positioned opposed to the light receiving member.

12. The substrate cleaning apparatus of claim 8, further comprising a controller that controls an operation of the driving member in accordance with a sensing signal generated from the sensor.

13. The substrate cleaning apparatus of claim 8, wherein the substrate transfer robot is disposed between the load port and the processing module.

14. The substrate cleaning apparatus of claim 8, wherein the processing module comprises:
a spin chuck that supports and revolves the substrate transferred by the substrate transfer robot;
a first solution providing member that provides a cleaning solution and a rinsing solution onto upper faces of the substrates supported by the spin chuck; and
a second solution providing member that provides the cleaning solution and the rinsing solution onto lower faces of the substrates supported by the spin chuck.

15. The substrate cleaning apparatus of claim 14, wherein the processing module further comprises:
an ultrasonic transducer that generates an ultrasonic energy; and
a probe coupled to the ultrasonic transducer and disposed adjacent to the substrates so as to apply the ultrasonic energy to the cleaning solution provided on the substrates.

16. The substrate cleaning apparatus of claim 14, wherein the spin chuck comprises:
a rotation driving member that provides a rotation force to revolve the substrates;
a rotation axle connected to the rotation driving member;
a plurality of spokes radially extending from the spin chuck;
an outer rim supported by the spokes; and
a plurality of supporting members disposed on the outer rim to support the substrates.

17. The substrate cleaning apparatus of claim 16, wherein the second solution providing member comprises a plurality of nozzles that provide the cleaning solution and the rinsing solution onto the lower faces of the substrates, the plurality of nozzles being disposed under the substrates supported by spokes and being elongated in parallel with the lower faces of the substrates.

18. The substrate cleaning apparatus of claim 17, wherein the processing module further comprises an additional sensor disposed on the second solution providing member to sense the substrates supported by the spin chuck.

19. The substrate cleaning apparatus of claim 14, wherein the processing module further comprises a dry gas providing member that provides a dry gas onto the substrates to dry the substrates rinsed using the rinsing solution.
